(19) United States
(12) Patent Application Publication
(10) Pub. No.: US 2008/0308174 A1
(43) Pub. Date: Dec. 18, 2008

(54) Method and Device for Supplying Fill Gas to a Cargo Tank

(76) Inventor: Oystein Huglen, Hafrsfjord (NO)

Correspondence Address: BOHAN MATHERS, PO BOX 17707, PORTLAND, ME, 04112-8707, US

(21) Appl. No.: 11/658,790

(22) PCT Filed: Jul. 4, 2005
(86) PCT No.: PCT/NO05/00251

§ 371 Date: Mar. 12, 2007

(30) Foreign Application Priority Data
Jul. 27, 2004 (NO) 20043198

(51) Int. Cl. B67D 5/68

(52) U.S. Cl. 141/11; 141/69

(57) ABSTRACT

Method and apparatus for supplying a fill gas to a cargo or storage tank that holds crude oil/gas condensate. The fill gas flows into the tank together with the crude oil/gas condensate in a common filling line. A separator at the tank separates the fill gas from the crude oil/gas condensate. The fill gas is then filled into the tank at a level above the liquid fill level of the crude oil/gas condensate.

This invention relates to a method for supplying a fill gas to a cargo tank. More particularly, it concerns a method, in which there is preferably used a hydrocarbon gas, referred to below as HC gas, as fill gas in a cargo tank, the gas being supplied in a controlled amount to the cargo tank together with the fluid which is being loaded. The invention also includes a device for practising the method.

In a cargo tank for crude oil/gas condensate, typically on board a ship, during filling and storing there will typically be some evolution of gas of volatile organic compounds, VOC, from the load mixing with the gas present in the cargo tank above the liquid crude oil/gas condensate. Among other things, to overcome the risk of igniting one of these gases, it is common to use a fill gas above the liquid load in the cargo tank. The fill gas is used to displace an oxygenic atmosphere, so that this becomes non-flammable. Somewhat misleading, this gas is normally referred to as inert gas and normally includes, according to the prior art, waste gases from a combustion, the portion of oxygen in the so-called inert gas typically being less than 8 percent.

According to the prior art the gas above the petroleum load thus includes a mixture of VOC and waste gases from a combustion process.

As the cargo tanks are filled, or as the evaporation of VOC otherwise increases, the pressure in the cargo tanks will rise. When this pressure exceeds a specific level, the gas is vented from the cargo tank. Among other things, to meet the requirements from the authorities as to reduced emissions into the atmosphere, the gas is treated by VOC gas being separated from the remaining gas and used for various purposes, possibly being absorbed into the petroleum load again.

A plant for separating VOC from combustion gases is relatively expensive. Production of waste gases for filling cargo tanks involves combustion of considerable amounts of fuel and thus also adds to increased emission of, among other things, carbon dioxide. Off-shore storage ships must typically be supplied with fuel from shore by means of supply vessels with the cost thereby entailed.

From production plants for crude oil/gas condensate it is known to transfer hydrocarbon gases, HC, as fill gas above liquid crude oil/gas condensate. As only insignificant amounts of oxygen are present, the possibility of igniting the HC gas has been sufficiently reduced.

For storage and cargo ships it has not been practically feasible to use pure HC gas as fill gas because, according to the prior art, this will require a separate pipe connection for the HC gas between the production plant and the ship.

The invention has as its object to remedy or reduce at least one of the drawbacks of the prior art.

The object is achieved in accordance with the invention through the features specified in the description below and in the following Claims.

The invention is realized through a method for supplying a fill gas to a cargo tank for crude oil/gas condensate. The crude oil/gas condensate flows to the cargo tank through a filling line, fill gas is mixed in in the filling line and flows together with the crude oil/gas condensate through the filling line, at least in a portion of the filling line, into the cargo tank.

It may be advantageous for the fill gas to be separated from the crude oil/gas condensate in or immediately before flowing into the cargo tank.

The best effect of the method is achieved if the amount of fill gas flowing together with the crude oil/gas condensate in the filling line is controlled by means of a pressure gauge measuring the gas pressure of the cargo tank.

The method is particularly suitable in the case of using a hydrocarbon gas as fill gas.

It is a considerable advantage of the method and the device according to the invention that fill gas that becomes superfluous in the cargo tank, can be used directly for the production of electricity, for example.

The invention described above is just as suitable for all kinds of vessels and fixed storage tanks, to/from which crude oil/gas condensates in a liquid form are supplied and discharged. The term storage ship is chosen for reasons of illustration and does not limit the scope of the invention to vessels of this kind only.

In what follows, there is described a non-limiting example of a preferred method and embodiment which are visualized in the accompanying drawings, in which:

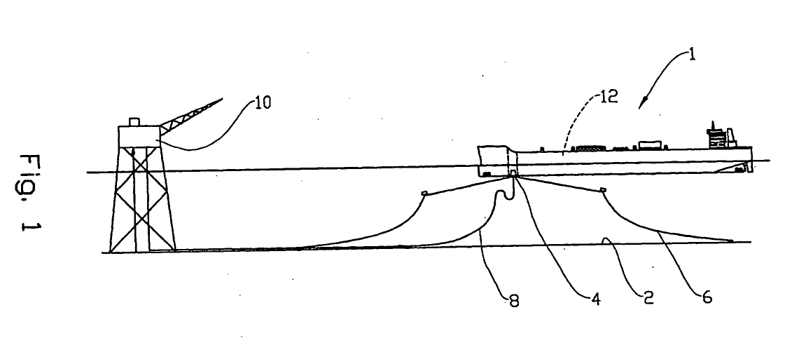

FIG. 1 shows a storage ship which is connected to a production unit, in which crude oil/gas condensate is transferred from the production unit to the storage ship;

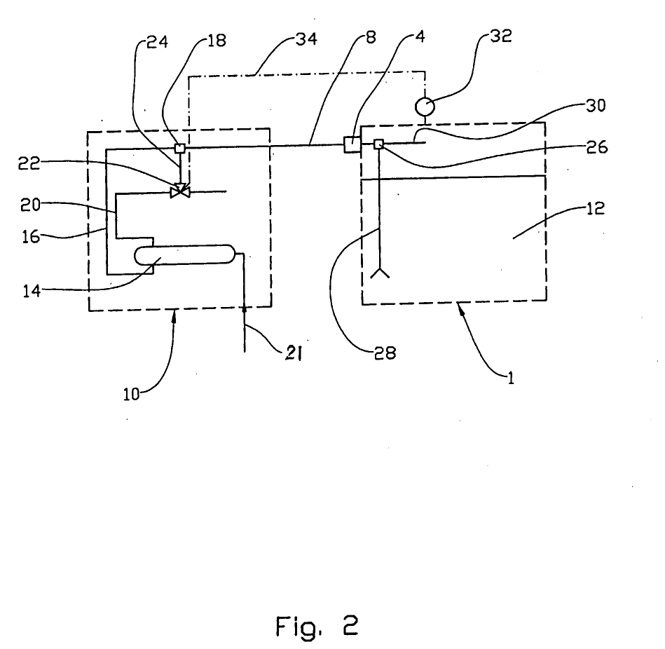

FIG. 2 shows a principle drawing of a loading system in accordance with the invention; and

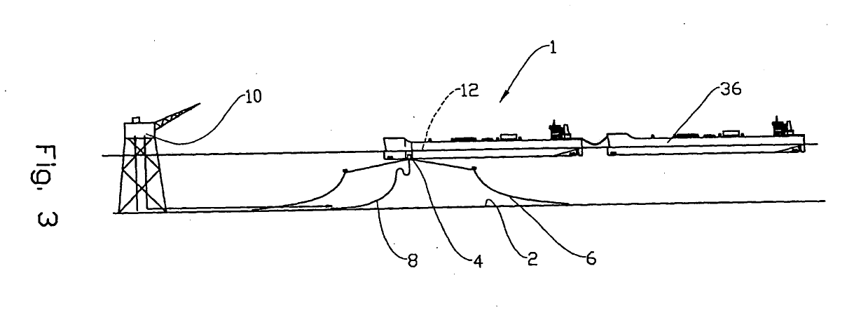

FIG. 3 shows the same as FIG. 1, but here a tanker is connected to the storage ship as liquid crude oil/gas condensate is loaded into the tanker.

In the drawings the reference numeral 1 identifies a storage ship which is moored to the sea bed 2 by means of a connection 4 and associated anchoring 6. A filling line 8 extends from a production plant 10 via the connection 4 to the cargo tank 12 of the storage ship 1.

To the production plant 10, see FIG. 2, well fluid is flowing from a petroleum well, not shown, via a well fluid pipe 21 to a processing plant 14. In the processing plant 14 the well fluid is separated into, among other things, a liquid crude oil/gas condensate which flows on through a liquid pipe 16 up to a mixing unit 18, and an HC gas which flows on through a gas pipe 20 up to a distributing valve 22. An intermediate pipe 24 connects the distributing valve 22 to the mixing unit 18.

The filling line 8 is connected to the mixing unit 18 of the production plant 10 and extends, as earlier mentioned, via the connection 4 to the cargo tank 12, where the filling line 8 is connected to a separator 26. From the separator 26 the liquid crude oil/gas condensate flows down into the cargo is tank 12 through a pipe 28, whereas the HC gas flows out into the upper portion of the cargo tank 12 via a pipe 30.

A pressure gauge 32 measures the pressure in the cargo tank 12 and communicates by means of a control of a kind known in itself, which is indicated by means of the line 34 in FIG. 2, with the distributing valve 22.

While a liquid crude oil/gas condensate is flowing into the cargo tank 12, which has previously been filled with HC gas, the pressure in the cargo tank 12 is measured by means of the pressure gauge 32. If the pressure in the cargo tank 12 falls below a predetermined value, the distributing valve 22 is controlled into directing more HC gas from the gas pipe 20 via the intermediate pipe 24 and the mixing unit 18 into the filling line 8. The HC gas thereby flows together with the liquid crude oil/gas condensate via the filling line 8 to the separator 26. Excess HC gas from the distributing valve 22 flows to other points of consumption, not shown, in the production plant 10.

If the pressure in the cargo tank 12 rises over a predetermined value, the inflow of HC gas from the distributing valve 22 to the mixing unit 18 is reduced, while at the same time the consumption of HC gas on the storage ship 1 may possibly be increased.

In a further exemplary embodiment, see FIG. 3, a tanker 36 is connected to the storage ship 1. During unloading from the storage ship 1 into the tanker 36 the cargo tanks 12 are replenished with HC gas from the production plant 10 as the liquid crude oil/gas condensate is flowing into the tanker 36.

1-8. (canceled)

9: A method for supplying a fill gas to a tank which holds crude oil/gas condensate, said method comprising the steps of:
(a) flowing crude oil/gas condensate through a filling line from a first location to a tank;
(b) mixing a fill gas into said filling line, such that said fill gas flows together with said crude oil/gas condensate through said filling line; wherein said fill gas is a hydrocarbon gas.

10: The method of claim 9 further comprising the steps of:
(c) providing a separator at an inlet on said tank;
(d) separating said fill gas from said crude oil/gas condensate at said separator; and
(e) filling said crude oil/gas condensate as a liquid into said tank.

11: The method of claim 10 further comprising the step of:
(f) filling said fill gas that has been separated from said crude oil/gas condensate into said tank above a liquid level of said crude oil/gas condensate.

12: The method of claim 9 further comprising the step of:
(g) providing a fill-gas control system for measuring a gas pressure in said tank.

13: The method of claim 12, the step (g) further including the steps of:
(g1) measuring a gas pressure in said tank;
(g2) communicating gas pressure information to a distribution device; and
(g3) regulating an amount of said fill gas flowing into said filling line, based on a measurement of said gas pressure in said tank.

14: The method of claim 9 further comprising the step of:
(h) separating hydrocarbon gasses from said crude oil/gas condensate at a processing plant; and
(i) transporting said hydrocarbon gasses to said fill gas feed line to serve as said fill gas and transporting said crude oil/gas condensate to said crude oil/gas condensate feed line.

15: Apparatus for supplying a fill gas to a tank to be loaded with a liquid crude oil/gas condensate, said apparatus comprising:
a mixing unit;
a crude oil/gas condensate feed line carrying a crude oil/gas condensate to said mixing unit;
a fill gas feed line carrying a fill gas to said mixing unit;
wherein said mixing unit mixes said crude oil/gas condensate and said fill gas to a delivery fluid; and
a filling line coupled between said mixing unit and said tank for delivering said delivery fluid to said tank.

16: The apparatus of claim 15, further comprising a fill-gas control system that includes a pressure control device for measuring a pressure in said tank.

17: The apparatus of claim 16, said fill-gas control system further including a distributing valve connected between said fill gas feed line and said mixing unit, wherein said pressure control device is communicably coupled with said distributing valve, and wherein said distributing valve controls an inflow of fill gas into said mixing unit, based upon a measurement of said pressure in said tank.

18: The apparatus of claim 17, further comprising:
a separator located at an inlet on said tank, for receiving said delivery fluid from said filling line and separating said fill gas from said crude oil/gas condensate;
a first outflow pipe for feeding said crude oil/gas condensate from said separator to said tank; and
a second outflow pipe for feeding said fill gas from said separator to said tank.

19: The apparatus of claim 18, wherein an outlet of said second outflow pipe feeds is placed above a liquid fill level of said crude oil/gas condensate.

20: The apparatus of claim 15 further comprising a connector for coupling said filling line to said tank.

21: The apparatus of claim 15 further comprising a crude oil processing plant for receiving well fluid and separating hydrocarbon gasses from said crude oil/gas condensate, wherein said hydrocarbon gasses are provided to said fill gas feed line and said crude oil/gas condensate is provided to said crude oil/gas condensate feed line.
